(19) United States
(12) Patent Application Publication
(10) Pub. No.: US 2026/0158381 A1
(43) Pub. Date: Jun. 11, 2026

(54) GAME MAKER MODEL FOR GENERATING A 3D OBJECT

(71) Applicant: Lemon Inc., Grand Cayman (KY)

(72) Inventors: Peilin Li, Los Angeles, CA (US); Jagminder Singh Shergill, Los Angeles, CA (US); Runze Zhang, Los Angeles, CA (US); Runjia Tian, Los Angeles, CA (US); Jie Meng, Los Angeles, CA (US); Jonathan Guzi, Culver City, CA (US); Shawn Kim, Culver City, CA (US)

(21) Appl. No.: 18/977,323

(22) Filed: Dec. 11, 2024

(51) Int. Cl. A63F 13/52; G06F 40/40; G06T 17/00

(52) U.S. Cl. CPC A63F 13/52; G06F 40/40; G06T 17/00

(57) ABSTRACT

A computing system executing a game maker model receives a user query including a description of the 3D object, generates an input prompt based on the user query, encodes the input prompt into embeddings, inputs the embeddings into a control network to generate latent features, inputs the latent features and the embeddings into a diffusion model to generate a 2D image, and generates and outputs the 3D object based on the 2D image.

### BACKGROUND

The development of game applications is a complex and resource-intensive process that involves multiple phases, including concept creation, design, programming, and testing. Traditionally, most game development has been limited to professional game developers due to the specialized skills and significant time investment required. As the demand for engaging and innovative gaming content has increased, the industry has sought more efficient and automated methods that make game development more accessible to casual users.

In recent years, advancements in machine learning and natural language processing (NLP) have opened new possibilities for automating creative and technical tasks across various industries. Despite these advancements, the process of designing and building game applications has yet to fully harness the capabilities of language models.

### SUMMARY

In view of the above issues, a computing system is provided for generating a 3D object. The computing system includes processing circuitry and memory storing a game maker model and instructions that, when executed, cause the processing circuitry to receive a user query including a description of the 3D object, generate an input prompt based on the user query, encode the input prompt into embeddings, input the embeddings into a control network to generate latent features, and input the latent features and the embeddings into a diffusion model to generate a 2D image. The system generates and outputs the 3D object based on the 2D image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the game maker model of the computing system of FIG. 1.

FIG. 3 illustrates an exemplary detailed schematic of a user query and a response, including an object and a natural language response, outputted by the game maker model of FIGS. 1 and 2.

FIG. 4 illustrates an example of the game application outputted by the game maker in the example of FIG. 3.

FIG. 5 is a flow chart of a method for generating a game application according to an example embodiment of the present disclosure.

FIG. 6 shows an example computing environment of the present disclosure in which the computing system of FIG. 1 may be enacted.

### DETAILED DESCRIPTION

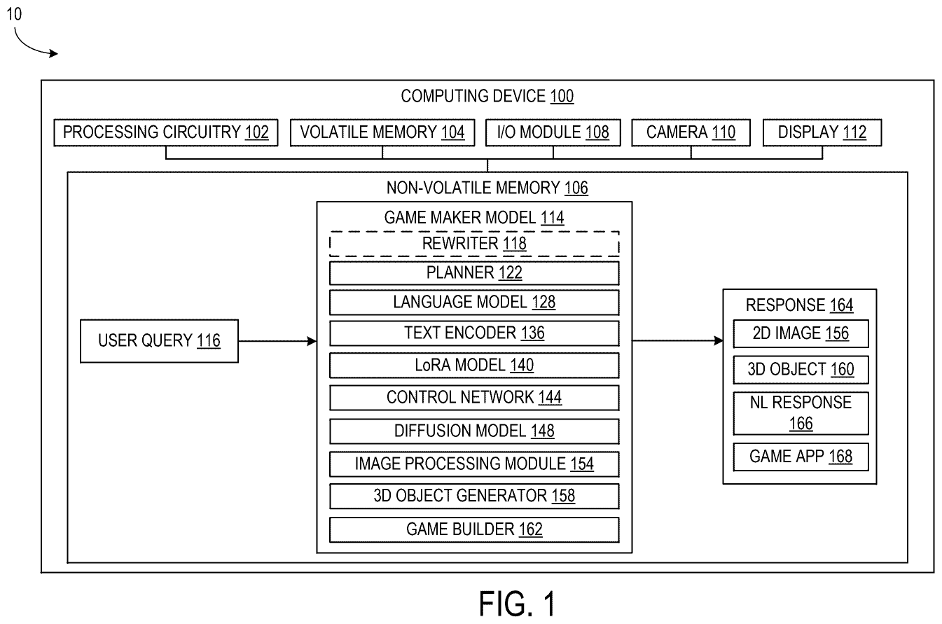

FIG. 1 shows a schematic view of a first example computing system 10 including a computing device 100 for generating a 3D object 160 using a game maker model 114. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the game maker model 114 which is configured to receive a user query 116 and generate a response 164 including the 3D object 160 and a natural language response 166 based on the user query 116.

The game maker model 114 may include a rewriter 118 configured to rewrite the user query 116. The game maker model 114 further includes a planner 122 configured to generate a user input prompt, a negative prompt, and a conditioning image based on the user query 116. The game maker model 114 also includes a text encoder 136 configured to encode the user input prompt and the negative prompt to generate token embeddings, a Low-Rank Adaptation (LoRA) model 140 configured to generate low-rank parameter matrices based on the token embeddings, a control network 144 configured to receive input of the token embeddings and the conditioning image to generate latent features, and a diffusion model 148 configured to receive input of the latent features, embeddings, and the low-rank parameter matrices to generate raw image data. The game maker model 114 also includes an image processing module 154 configured to generate a 2D image 156 based on the raw image data, a 3D object generator 158 configured to generate a 3D object 160 based on the 2D image 156, and a game builder 162 which is configured to generate a game application 168 including the 3D object 160, and also generate a response 164 including the 2D image 156, the 3D object 160 and a natural language response 166. In one specific example, the diffusion model 148 may be the Stable Diffusion model and the control network 144 may be the ControlNet for the Stable Diffusion model.

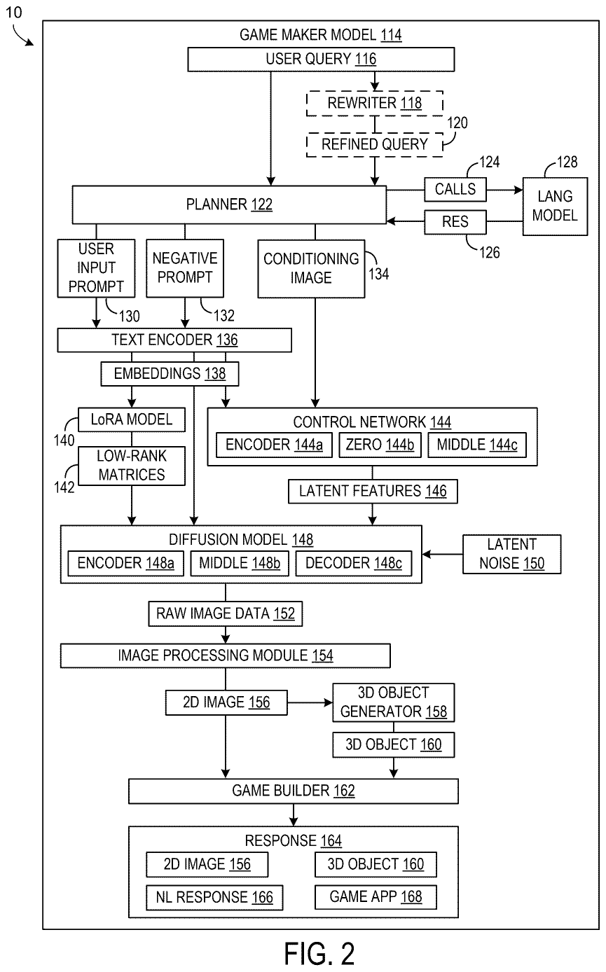

Referring to FIG. 2, the operations of the game maker model 114 are described in further detail. The game maker model 114 uses a modular approach for the automated generation of a 3D object 160 and a game application 168 based on the user query 116, leveraging a language model 128 to interpret and guide the object creation process. The game maker model 114 receives a user query 116 including a description of the 3D object 160. Responsive to receiving the user query 116, the rewriter 118 may rewrite the user query 116 to generate a refined query 120 that may clarify the request of the user. The rewriter 118 may be a language model, for example.

The user query 116 and/or the refined query 120 are fed into the planner 122, which interprets the user query 116 and/or the refined query 120 into prompts 124 or calls that guide subsequent content creation through the language model 128. The calls 124 are inputted into the language model 128 to generate responses 126 that are subsequently consolidated by the planner 122 into a user input prompt 130 and a negative prompt 132, which are structured as high-level instructions for generating the desired 3D object 160.

The language model 128 may be trained on a diverse database of paired user prompts and descriptions of 3D objects covering a wider range of user queries and 3D objects. This training database acts as ground truth, providing the language model 128 with both simple and complex examples of how to translate natural language requests 116 into a structured user input prompt 130 and a negative prompt 132.

The user input prompt 130 may list the elements, styles, colors, types, and/or perspective of the desired 3D object 160. For example, a user input prompt 130 may specify a black sports car in a right-side view. The negative prompt 132 may list elements, styles, or perspective to be avoided during image generation. For example, when it is determined that a right-side view of the object is to be generated, the negative prompt 132 may be generated to list the terms “from the left,” “facing left,” “from above,” “from below,” or “back view” as terms to avoid to refrain from generating images from angles other than the desired right-side view. Further, the negative prompt 130 may include elements like “portrait,” “bust,” “head,” “cropped,” or “cutoff” to steer the diffusion model 148 away from generating close-ups or incomplete views of the subject. Accordingly, the angle, size, and orientation of the generated 2D image 156 can be consistently controlled.

The planner 122 generates a conditioning image 134 based on the perspective of the desired 3D object 160 that is indicated in the user input prompt 130. For example, when the user input prompt 130 indicates a side view of the desired object, the planner 122 may generate a simple geometric image of a rectangular block as the conditioning image 134 to be inputted into the control network 144 to guide the image generation process of a 2D sideview image 156 of the desired 3D object 160.

The text encoder 136 receives the user input prompt 130 and the negative prompt 132 as input and generates token embeddings 138 based on the user input prompt 130 and the negative prompt 132. The text encoder 136 may be configured as a CLIP (Contrastive Language-Image Pre-Training) text encoder, for example. The generated token embeddings 138 may be concatenated before being fed into a LoRA model 140, the control network 144, and the diffusion model 148.

The diffusion model 148 is a pre-trained diffusion model that generates images from latent noise 150 through iterative denoising steps, in which the noise 150 is processed through a series of convolutional layers and attention mechanisms to progressively refine the image. The layers and mechanisms include an encoder 148a comprising a first set of blocks, a middle block 148b comprising a second set of blocks, and a decoder 148c comprising a third set of blocks. The encoder 148a downsamples the latent noise 150, and the decoder 148c upsamples the latent representations back to the original resolution to generate the raw image data 152.

The diffusion model 148 uses U-Net architecture, which processes the noise in a denoising process through a series of ResNet blocks and attention layers in the encoder 148a, the middle block 148b, and the decoder 148c, progressively refining the image to generate the raw image data 152. The token embeddings 138 are inputted into the attention layers of the encoder 148a, the middle block 148b, and/or the decoder 148c of the diffusion model 148 as the denoising process progresses so that the raw image data 152 reflects the prompt features of the user input prompt 130 and the negative prompt 132.

The control network 144 comprises an encoder 144a which is a trainable copy of the encoder 148a of the diffusion model 148. The control network 144 also includes zero-initialized convolutional layers 144b that are placed at the output of the encoder 144a, and a middle block 144c which is a trainable copy of the middle block 148b of the diffusion model 148. The conditioning image 134 is inputted into the encoder 144a of the control network 144. The token embeddings 138 may be inputted into the attention layers of the encoder 144a and/or the middle block 144c. The zero-initialized convolutional layers 144b, which are 1×1 convolutional layers with both weights and biases introduced to zeros, transform the features generated by the encoder 144a before injection into the diffusion model 148 as latent features 146 or control signals of the control network 144. The latent features 146 outputted by the control network 144 are inputted into the skip-connections and middle block 148b of the diffusion model 148. The skip-connections, which are direct links that connect the encoder layers of the encoder 148a to the corresponding decoder layers of the decoder 148c, preserve spatial information that may have been lost during the downsampling process in the encoder 148a.

Responsive to receiving the token embeddings 138, the LoRA model 140 generates fine-tuned low-rank parameter matrices 142 that are added to the weights of the stable diffusion model 148. The conditioning image 134 is processed by the control network 144 to generate a latent map that aligns with the internal representation of the stable diffusion model 148 with the shape of the conditioning image 134. When the planner 122 generates a conditioning image 134 corresponding to a side view of the 3D object 160, the input of the conditioning image 134 into the control network 144 ensures that the generated 2D image 156 does not deviate from the specified side view. The control network 144 also accepts input of the token embeddings 138 generated by the text encoder 136.

The raw image data 152 outputted by the stable diffusion model 148 may be further processed by the image processing module 154. For example, the image processing module 154 may refine the raw image data 152 by ensuring that the object depicted in the images faces the correct orientation, enhancing specific features in the raw image data 152, such as the outline of the object in the image 152, and scaling the image 152 to the appropriate size for display.

The 3D object generator 158 generates a 3D object 160 based on the 2D image 156, inferring the geometry of the entire object based on the view that is represented by the 2D image 156. In one example, the 2D image 156 is a right-side view of the 3D object 160. By assuming that the 3D object 160 has a symmetric structure, the 3D object generator 158 infers the left-side view of the 3D object 160 as well as a top view, a back view, and a front view of the 3D object 160. A 3D object template may be used by the 3D object generator 158 to generate 3D objects 160 with known geometries, such as cars.

The game builder 162 constructs the final game application 168 based on the generated 2D image 156 and 3D object 160. The game construction process may be facilitated by visual scripting logic to connect modular elements of the game together. The game builder 162 may use the language model 128 to gather details about the design and mechanics of the game application 168 based on the user query 116, and populate and structure a game configuration that is used to select and connect the modular elements of the game together.

The game builder 162 may ensure that the generated 3D object 160 fits in the layout of the game application 168, so as to ensure compatibility with the road texture, obstacle placement, and background, for example, thereby reducing the need for manual intervention and accelerating the game development process. Accordingly, the scale and visual aesthetics of the game application 168 may be consistent when incorporating the 3D object 160 as a playable character.

The game builder 162 may not only generate the final game application 168, but also generate an output response 164 including a preview of the 2D image 156 and 3D object 160. The output response 164 may also include a natural language response 166, which provides a descriptive summary or relative guidance regarding the generated 3D object 160, offering the user a comprehensive overview of the generated game application 168 and their generated 3D object 160. The 3D object 160 may be rendered in the game application 168 on a user interface on a social media platform, for example.

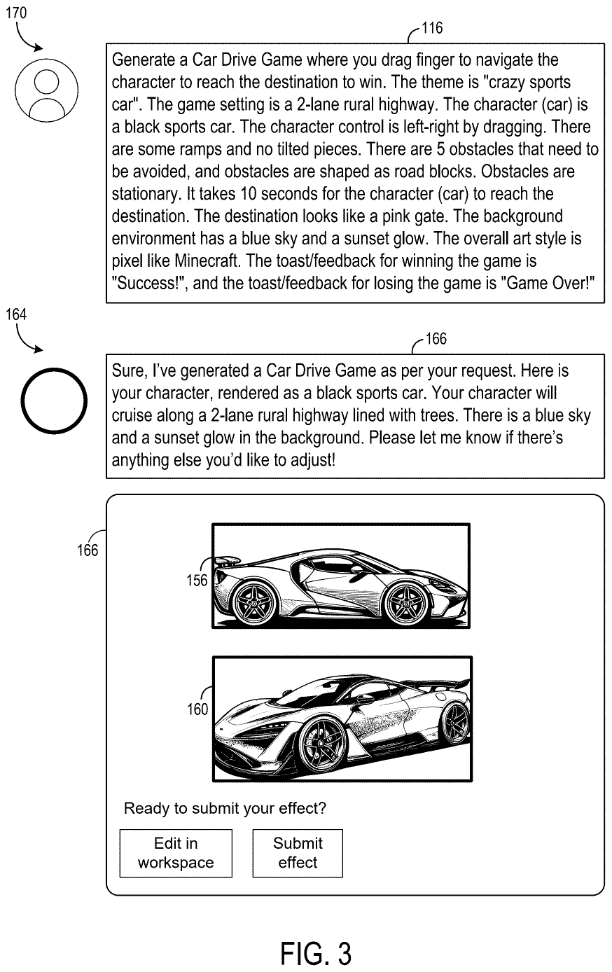

FIG. 3 illustrates the user interface 170 in the example of FIG. 2, in which the user inputs the user query 116, “Generate a Car Drive Game . . . the character (car) is a black sports car”. The user interface 170 may be displayed on the display 112 of the computing device 100 of FIG. 1. Responsive to receiving the user query 116, the game maker model 114 generates a response 164 including a preview of the generated 2D image 156 and 3D object 160. The response 164 also includes a natural language response 166 which provides a descriptive summary or relative guidance regarding the generated 3D object 160, offering the user an overview of the generated game application 168 and their generated 3D object 160. In this example, the natural language response 164 explains that the user's character, rendered as a black sports car, will cruise along a two-lane rural highway lined with trees, and the background has a blue sky and sunset glow. The response 164 also includes a prompt asking the user whether the ‘effect’ is ready to be submitted or edited further in the workspace. In other words, the response 164 invites a subsequent user query to modify the generated 3D object 160 or the game application 168.

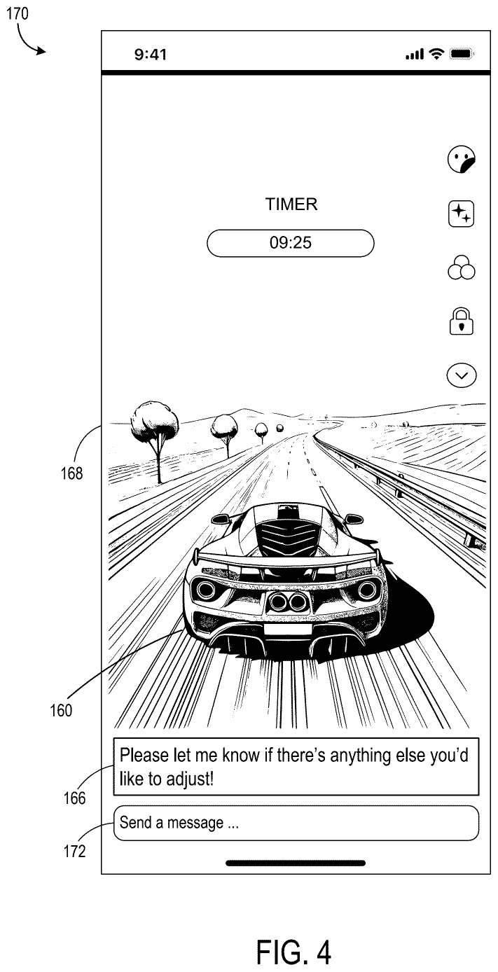

FIG. 4 illustrates the game application 168 being executed on a user interface 170 in the example of FIG. 3, in which the user has generated a 3D object 160 of a black sports car, and the game application 168 incorporates the 3D object 160 as a playable character which cruises along a two-lane rural highway. The user interface 170 may be displayed on the display 112 of the computing device 100 of FIG. 1. Responsive to receiving the user query 116, the game maker model 114 generates a game application 168 including the generated 3D object 160 as a playable character. The user interface 170 may also include the natural language response 166 which provides a descriptive summary or relative guidance regarding the generated 3D object 160 and the game application 168. In this example, the natural language response 166 invites a subsequent user query to modify the generated 3D object 160 and/or the game application 168. The user may enter a subsequent user query in a text entry box 172 at the bottom of the user interface 170.

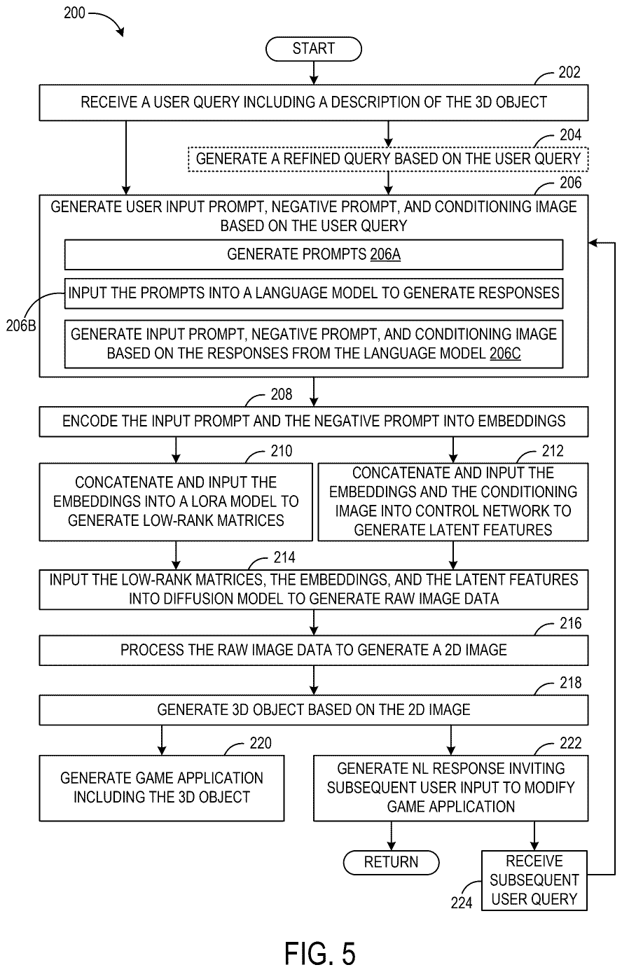

FIG. 5 shows a process flow diagram of an example method 200 for generating a 3D object. The example method 200 may be executed by the processing circuitry 102 and memory 104 of the computing system 10 of FIG. 1. The example method 200 includes, at step 202, receiving a user query including a description of the 3D object. Method 200 may include step 204 of generating a refined query based on the user query, and step 206 of generating a user input prompt, a negative prompt, and a conditioning image based on the refined query. At step 206, the method 200 includes generating a user input prompt, a negative prompt, and a conditioning image based on the user query. Step 206 may include step 206A of generating prompts, step 206B of inputting the prompts into a language model to generate responses, and step 206C of generating the user input prompt, the negative prompt, and the conditioning image based on the responses from the language model.

The method 200 includes step 208 of encoding the input prompt and the negative prompt into embeddings. At step 210, the embeddings are concatenated and inputted in a LoRA model to generate low-rank parameter matrices. At step 212, the embeddings are concatenated and inputted into the control network along with the conditioning image to generate latent features.

At step 214, the method includes inputting the low-rank parameter matrices, the concatenated embeddings, and the latent features into the diffusion model to generate raw image data. At step 216, the raw image data is processed to generate a 2D image. At step 218, a 3D object is generated based on the 2D image.

At step 220, the method 200 includes generating a game application including the 3D object and the 2D image. At step 222, the method 200 includes generating a natural language response inviting a subsequent user query to modify the object. When, at step 224, a subsequent user query is received, the method 200 proceeds to step 206 of generating the user input prompt, the negative prompt, and the conditioning image based on the subsequent user query.

As described throughout herein, by leveraging language models to enable users to specify, customize, and refine 3D game objects using natural language prompts, 3D game object creation may be made more accessible to users. The 3D game object may be generated to maintain consistency in terms of angle, orientation, dimensions, style, color, and type relative to the game environment. By ensuring that game objects have fixed angles, orientations, and dimensions, distortions or misalignment may be avoided in the rendering of the game objects during gameplay.

The above-described system and method not only simplify the process of creating 3D game objects, but also empower users to generate comprehensive game applications with professional-quality game objects in a fraction of the time. Broad applications may be found not only for enhancing user-generated game applications, but also for generating 3D objects in social media platforms as well as other applications in entertainment, education, healthcare, and beyond.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

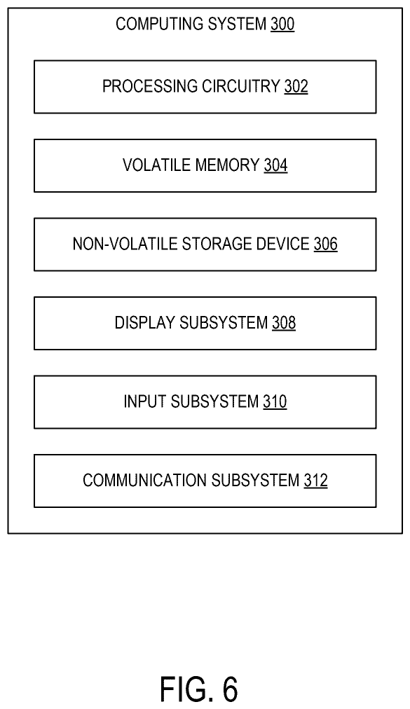

FIG. 6 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical object, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system for generating a 3D object, the computing system comprising processing circuitry and memory storing a game maker model and instructions that, when executed, causes the processing circuitry to receive a user query including a description of the 3D object, generate an input prompt based on the user query, encode the input prompt into embeddings, input the embeddings into a control network to generate latent features, input the latent features and the embeddings into a diffusion model to generate a 2D image, and generate and output the 3D object based on the 2D image. In this aspect, additionally or alternatively, a conditioning image may be generated based on the input prompt, and the conditioning image may be inputted into the control network to generate the latent features. In this aspect, additionally or alternatively, the control network may comprise an encoder configured to be a trainable copy of an encoder of the diffusion model, zero-initialized convolutional layers placed at an output of the encoder of the control network, and a middle block configured to be a trainable copy of a middle block of the diffusion model, the conditioning image being inputted into the encoder of the control network, and the embeddings being concatenated and inputted into attention layers of the encoder and the middle block of the control network. In this aspect, additionally or alternatively, the embeddings may be inputted into a Low-Rank Adaptation model to generate low-rank parameter matrices, and the low-rank parameter matrices may be inputted into the diffusion model. In this aspect, additionally or alternatively, the input prompt may be encoded by a CLIP (Contrastive Language-Image Pre-Training) text encoder. In this aspect, additionally or alternatively, the embeddings may be concatenated and inputted into attention layers of the diffusion model. In this aspect, additionally or alternatively, the input prompt may be generated by generating one or more prompts, inputting the one or more prompts into a language model to generate one or more responses, and generating the input prompt based on the one or more responses. In this aspect, additionally or alternatively, the processing circuitry may be further configured to generate a game application including the 3D object. In this aspect, additionally or alternatively, the processing circuitry may be configured to further generate a natural language response inviting a subsequent user query to modify the 3D object. In this aspect, additionally or alternatively, the processing circuitry may be further configured to generate a negative prompt based on the user query, encode the input prompt and the negative prompt into the embeddings, and input the embeddings into the control network to generate the latent features.

Another aspect provides a computing method for generating a 3D object, the computing method comprising receive a user query including a description of the 3D object, generate an input prompt based on the user query, encode the input prompt into embeddings, input the embeddings into a control network to generate latent features, input the latent features and the embeddings into a diffusion model to generate a 2D image, and generate and output the 3D object based on the 2D image. In this aspect, additionally or alternatively, a conditioning image may be generated based on the input prompt, and the conditioning image may be inputted into the control network to generate the latent features. In this aspect, additionally or alternatively, the control network may comprise an encoder configured to be a trainable copy of an encoder of the diffusion model, zero-initialized convolutional layers placed at an output of the encoder of the control network, and a middle block configured to be a trainable copy of a middle block of the diffusion model, the conditioning image being inputted into the encoder of the control network, and the embeddings being concatenated and inputted into attention layers of the encoder and the middle block of the control network. In this aspect, additionally or alternatively, the embeddings may be inputted into a Low-Rank Adaptation model to generate low-rank parameter matrices, and the low-rank parameter matrices may be inputted into the diffusion model. In this aspect, additionally or alternatively, the input prompt may be encoded by a CLIP (Contrastive Language-Image Pre-Training) text encoder. In this aspect, additionally or alternatively, the embeddings may be concatenated and inputted into attention layers of the diffusion model. In this aspect, additionally or alternatively, the input prompt may be generated by generating one or more prompts, inputting the one or more prompts into a language model to generate one or more responses, and generating the input prompt based on the one or more responses. In this aspect, additionally or alternatively, the computing method may further comprise generating a game application including the 3D object. In this aspect, additionally or alternatively, the computing method may further comprise generating a negative prompt based on the user query, encoding the input prompt and the negative prompt into the embeddings, and inputting the embeddings into the control network to generate the latent features.

Another aspect provides a computing system for generating a game application, the computing system comprising processing circuitry and memory storing a game maker model and instructions that, when executed, causes the processing circuitry to receive a user query including a description of a 3D object, generate an input prompt based on the user query, encode the input prompt into embeddings, input the embeddings into a diffusion model to generate a 2D image, generate the 3D object based on the 2D image, and generate the game application including the 3D object as a playable character.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a 3D object, the computing system comprising:
processing circuitry and memory storing a game maker model and instructions that, when executed, causes the processing circuitry to:
receive a user query including a description of the 3D object;
generate an input prompt based on the user query;
encode the input prompt into embeddings;
input the embeddings into a control network to generate latent features;
input the latent features and the embeddings into a diffusion model to generate a 2D image; and
generate and output the 3D object based on the 2D image.

2. The computing system of claim 1, wherein
a conditioning image is generated based on the input prompt; and
the conditioning image is inputted into the control network to generate the latent features.

3. The computing system of claim 2, wherein
the control network comprises:
an encoder configured to be a trainable copy of an encoder of the diffusion model;
zero-initialized convolutional layers placed at an output of the encoder of the control network; and
a middle block configured to be a trainable copy of a middle block of the diffusion model, wherein
the conditioning image is inputted into the encoder of the control network; and
the embeddings are concatenated and inputted into attention layers of the encoder and the middle block of the control network.

4. The computing system of claim 1, wherein
the embeddings are inputted into a Low-Rank Adaptation model to generate low-rank parameter matrices; and
the low-rank parameter matrices are inputted into the diffusion model.

5. The computing system of claim 1, wherein the input prompt is encoded by a CLIP (Contrastive Language-Image Pre-Training) text encoder.

6. The computing system of claim 1, wherein the embeddings are concatenated and inputted into attention layers of the diffusion model.

7. The computing system of claim 1, wherein the input prompt is generated by generating one or more prompts, inputting the one or more prompts into a language model to generate one or more responses, and generating the input prompt based on the one or more responses.

8. The computing system of claim 1, wherein the processing circuitry is further configured to generate a game application including the 3D object.

9. The computing system of claim 1, wherein the processing circuitry is configured to further generate a natural language response inviting a subsequent user query to modify the 3D object.

10. The computing system of claim 1, wherein the processing circuitry is further configured to:
generate a negative prompt based on the user query;
encode the input prompt and the negative prompt into the embeddings; and
input the embeddings into the control network to generate the latent features.

11. A computing method for generating a 3D object, the computing method comprising:
receive a user query including a description of the 3D object;
generate an input prompt based on the user query;
encode the input prompt into embeddings;
input the embeddings into a control network to generate latent features;
input the latent features and the embeddings into a diffusion model to generate a 2D image; and
generate and output the 3D object based on the 2D image.

12. The computing method of claim 11, wherein
a conditioning image is generated based on the input prompt; and
the conditioning image is inputted into the control network to generate the latent features.

13. The computing method of claim 12, wherein
the control network comprises:
an encoder configured to be a trainable copy of an encoder of the diffusion model;
zero-initialized convolutional layers placed at an output of the encoder of the control network; and
a middle block configured to be a trainable copy of a middle block of the diffusion model, wherein
the conditioning image is inputted into the encoder of the control network; and
the embeddings are concatenated and inputted into attention layers of the encoder and the middle block of the control network.

14. The computing method of claim 11, wherein
the embeddings are inputted into a Low-Rank Adaptation model to generate low-rank parameter matrices; and
the low-rank parameter matrices are inputted into the diffusion model.

15. The computing method of claim 11, wherein the input prompt is encoded by a CLIP (Contrastive Language-Image Pre-Training) text encoder.

16. The computing method of claim 11, wherein the embeddings are concatenated and inputted into attention layers of the diffusion model.

17. The computing method of claim 11, wherein the input prompt is generated by generating one or more prompts, inputting the one or more prompts into a language model to generate one or more responses, and generating the input prompt based on the one or more responses.

18. The computing method of claim 11, further comprising generating a game application including the 3D object.

19. The computing method of claim 11, further comprising:
generating a negative prompt based on the user query;
encoding the input prompt and the negative prompt into the embeddings; and
inputting the embeddings into the control network to generate the latent features.

20. A computing system for generating a game application, the computing system comprising:
processing circuitry and memory storing a game maker model and instructions that, when executed, causes the processing circuitry to:
receive a user query including a description of a 3D object;
generate an input prompt based on the user query;
encode the input prompt into embeddings;
input the embeddings into a diffusion model to generate a 2D image;
generate the 3D object based on the 2D image; and
generate the game application including the 3D object as a playable character.
